(19) United States
(12) Patent Application Publication
(10) Pub. No.: US 2013/0319836 A1
(43) Pub. Date: Dec. 5, 2013

(54) HOUSING ASSEMBLY HAVING A PUSH BUTTON

(71) Applicants: DE-JUN CHEN, Shenzhen City (CN); FAN-ZHE DING, Shenzhen City (CN); YAN-QING ZHENG, Shenzhen City (CN); PEN-UEI LU, Tu-Cheng (TW)

(72) Inventors: DE-JUN CHEN, Shenzhen City (CN); FAN-ZHE DING, Shenzhen City (CN); YAN-QING ZHENG, Shenzhen City (CN); PEN-UEI LU, Tu-Cheng (TW)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/551,632

(22) Filed: Jul. 18, 2012

(30) Foreign Application Priority Data
May 30, 2012 (CN) 201210172801.7

(51) Int. Cl. H01H 13/06

(52) U.S. Cl. 200/302.2

(57) ABSTRACT

A housing assembly includes a housing, a push button, and a sealing member. The housing includes a bottom plate and a sidewall protruding from the bottom plate. The sidewall defines an opening therethrough and includes a protruding tab protruding from an inner side thereof and extending around the opening. The push button includes a button body extending through the opening and a pushing portion protruding from an inner side of the button body. The sealing member is made of elastic material and includes a first surface and an opposite, second surface. The first surface defines a receiving groove, and the protruding tab is tightly fit in the receiving groove. When the push button is pressed, the pushing portion pushes the sealing member and the sealing member is elastically deformed, thereby preventing liquid from entering the housing through a gap between the push button and the housing.

### BACKGROUND

1. Technical Field

The present disclosure relates to a housing assembly having a push button, which can prevent liquid from entering the housing assembly via the push button.

2. Description of Related Art

Housing assemblies for portable electronic devices, e.g., mobile phones, often include a housing and a push button assembled in the housing. The inside of the housing must be protected from being invaded by rain water or other liquid, so as to avoid the damage of the electronic components accommodated in the housing. Although conventional housing assemblies can satisfy basic requirement, a new type of the housing assembly which can prevent liquid from entering the housing assembly is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a housing assembly having a push button in accordance to an exemplary embodiment.

FIG. 2 is an isometric view of a housing assembly of FIG. 1, but viewed from a reverse perspective.

FIG. 3 is an exploded, isometric view of the housing assembly of FIG. 1.

FIG. 4 is an exploded, isometric view of the housing assembly of FIG. 1, but viewed from a reverse perspective.

FIG. 5 is a cross-sectional view of the housing assembly, cut along line IV-IV of FIG. 1.

### DETAILED DESCRIPTION

Embodiments of the present disclosure are described with reference to the accompanying drawings.

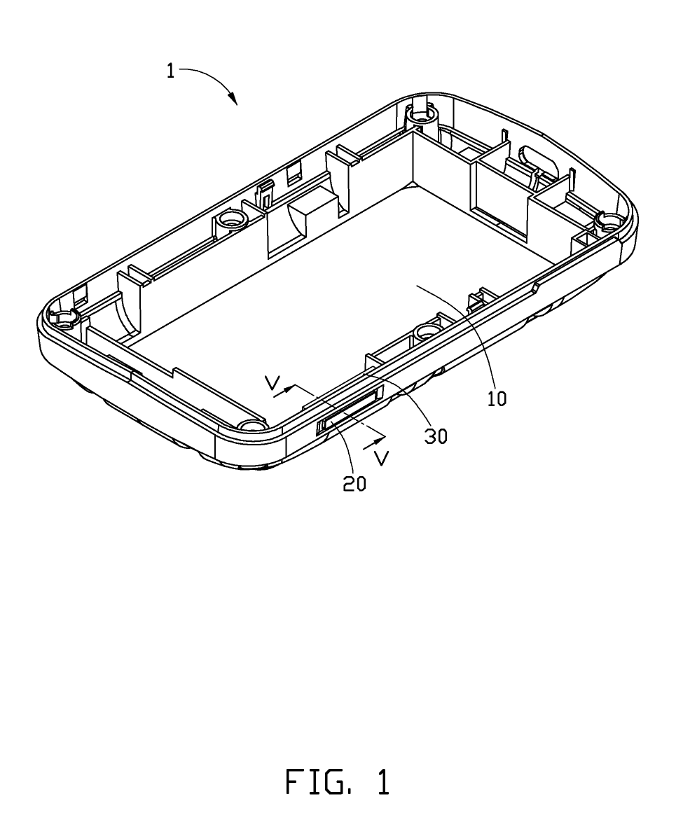

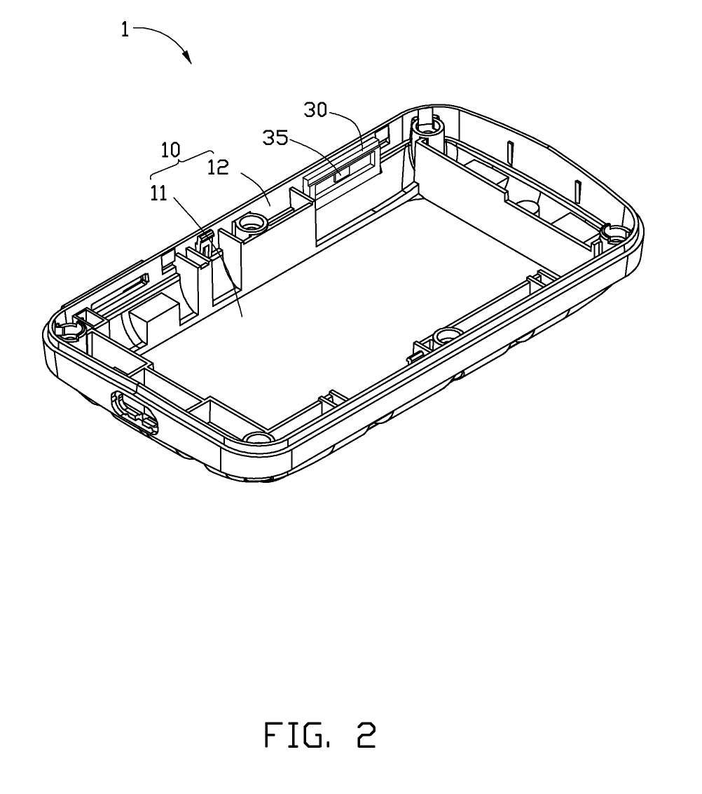

FIGS. 1-2 illustrate a housing assembly 1 according to an exemplary embodiment. The housing assembly 1 includes a housing 10 for accommodating electronic components (not shown), a push button 20 assembled in the housing 10, and a sealing member 30. The sealing member 30 is coupled to the housing 10 and can prevent liquid from entering the housing 10.

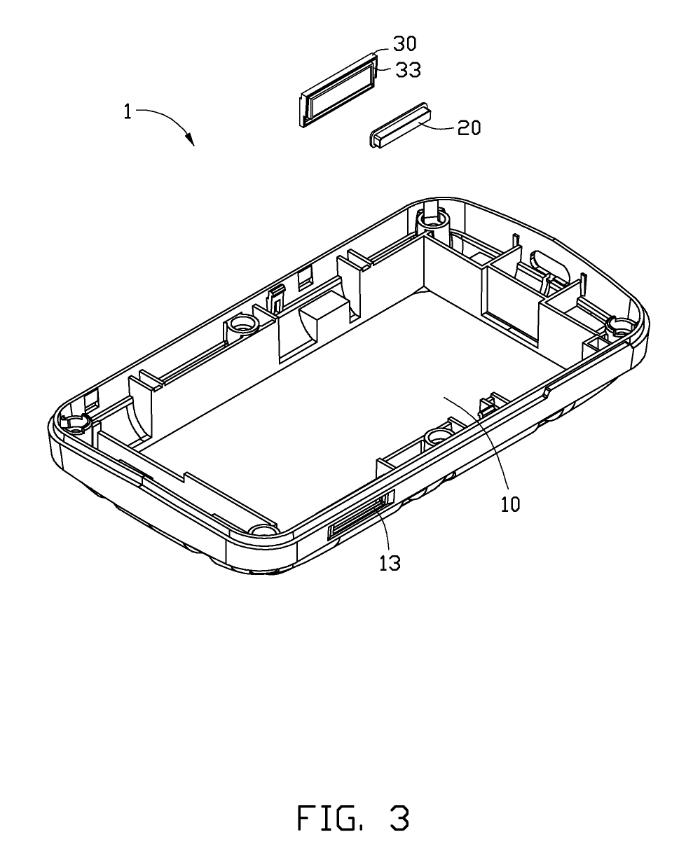

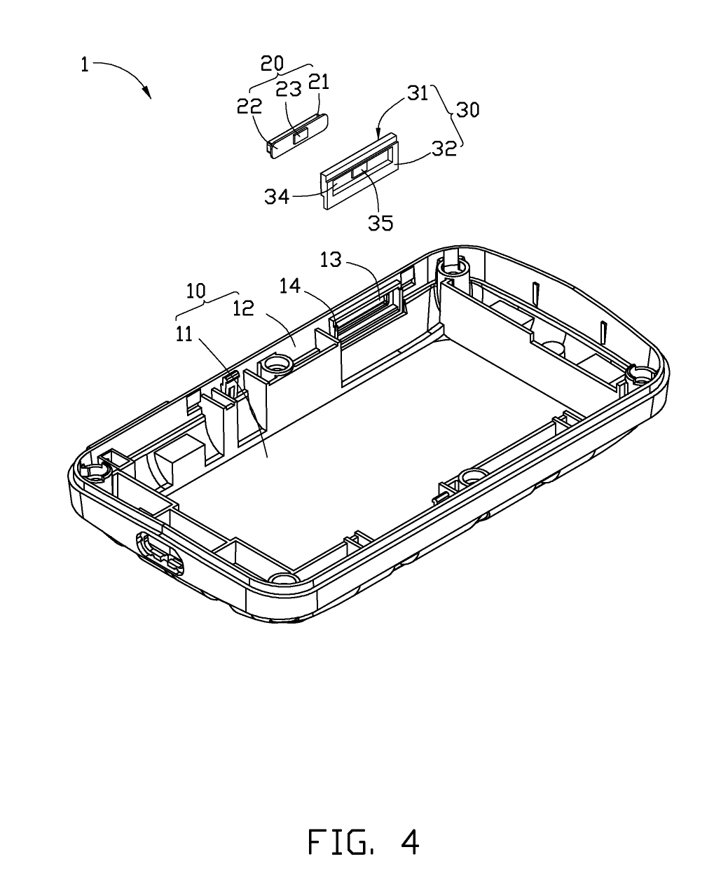

FIGS. 3-4 illustrate the housing 10 of one embodiment. The housing 10 includes a bottom plate 11 and a sidewall 12 protruding from the bottom plate 11. The sidewall 12 defines an opening 13 therethrough and includes a protruding tab 14 extending around the opening 13. The protruding tab 14 extends from an inner side of the sidewall 12, and the sealing member 30 is coupled to the protruding tab 14.

The push button 20 includes a button body 21, a projection 22 extending around the button body 21, and a pushing portion 23 protruding from an inner side of the button body 21. The size of the button body 21 is slightly less than that the size of the opening 13, and the size of the projection 22 is greater than that the size of the opening 13.

The sealing member 30 includes a first surface 31 and an opposite second surface 32. The first surface 31 defines a receiving groove 33 having a shape corresponding to the protruding tab 14 of the housing 10. The second surface 32 defines a recess 34 therein and includes an actuating portion 35 protruding from a bottom of the recess 34. The sealing member 30 is made of elastic material, e.g. rubber.

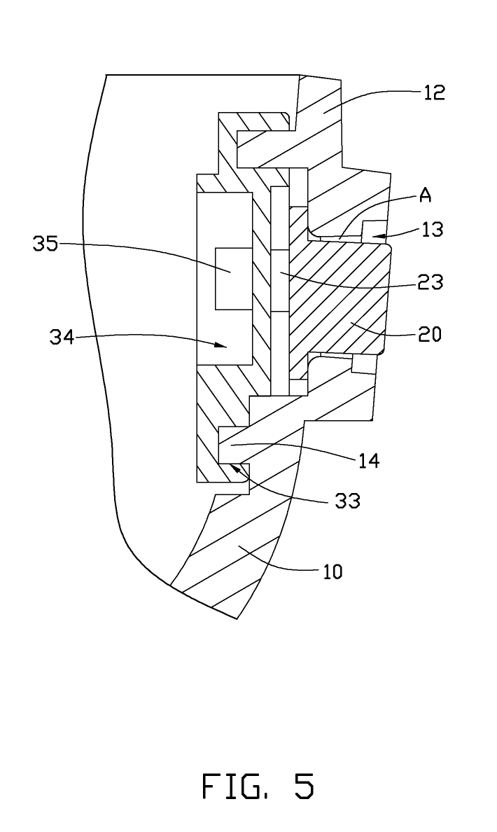

Referring to FIG. 5, during assembly, the button body 21 is inserted into the opening 13 from an inner side of the housing 10. The projection 22 resists against an inner side of the sidewall 12. The sealing member 30 is then orientated in such a way that the protruding tab 14 can be tightly fit in the receiving groove 33. The sealing member 30 is thereby coupled to the housing 10 forming a seal that can prevent liquid from entering the housing assembly 1 through the gap A between the button body 21 and the housing 10. After assembly, the pushing portion 23 is aligned with the actuating portion 35 of the sealing member 30. When the push button 20 is pressed, the pushing portion 23 pushes the sealing member 30 and causes the sealing member 30 to be elastically deformed, and then the actuating portion 35 actuates the switch (not shown) retained in the housing 10.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A housing assembly comprising:
a housing comprising a bottom plate and a sidewall protruding from the bottom plate, the sidewall defining an opening therethrough and comprising a protruding tab protruding from an inner side of the sidewall and extending around the opening;
a push button comprising a button body extending through the opening and a pushing portion protruding from an inner side of the button body; and
a sealing member made of elastic material and comprising a first surface and an opposite, second surface, the first surface defining a receiving groove, and the protruding tab being tightly fit in the receiving groove, wherein when the push button is pressed, the pushing portion pushes the sealing member and the sealing member is elastically deformed, thereby preventing liquid from entering the housing through a gap between the push button and the housing.

2. The housing assembly as described in claim 1, wherein the push button comprises a projection extending around the button body.

3. The housing assembly as described in claim 2, wherein the size of the button body is slightly less than the size of the opening, and the size of the projection is greater than that the size of the opening.

4. The housing assembly as described in claim 1, wherein the sealing member is made of rubber.

5. The housing assembly as described in claim 1, wherein the sealing member defines a recess in the second surface and forms an actuating portion protruding from a bottom of the recess, and the actuating portion is aligned with the push portion of push button.
